(19) United States
(12) Patent Application Publication
(10) Pub. No.: US 2006/0143580 A1
(43) Pub. Date: Jun. 29, 2006

(54) Method and system for quick screen switching in a multi-monitor environment

(75) Inventors: Joseph A. Gimness, Tucson, AZ (US); Brian S. McCain, Tucson, AZ (US); Jason L. Peipelman, Tucson, AZ (US)

Correspondence Address: SCULLY, SCOTT, MURPHY, & PRESSER, 400 GARDEN CITY PL, GARDEN CITY, NY, 11530, US

(73) Assignee: International Business Machines Corporation, Armonk, NY (US)

(21) Appl. No.: 11/017,523

(22) Filed: Dec. 20, 2004

(51) Int. Cl. G06F 3/00; G06F 17/00; G06F 9/00

(52) U.S. Cl. 715/856

(57) ABSTRACT

A cursor control device such as a mouse allows a user to quickly switch between screens in a multi-monitor computing environment. Available programmable buttons on the cursor control device are programmed to achieve a functionality for switching between display regions on different screens, or within a screen. With a click of the button, the cursor can switch to another display region on the same screen or a different screen. Moreover, the cursor can switch to a corresponding location or a predetermined, e.g., fixed, location. The cursor can cycle or alternate among display regions. When switching back to the starting display region, the cursor can return to its original location, a location corresponding to that in a previous display region, or a predetermined location. A user interface allows a user to configure the behavior.

### BACKGROUND OF THE INVENTION

1. Field of the Invention

The invention relates generally to the field of computer systems and, more specifically, to a technique for allowing a user to quickly switch between screens in a multi-monitor environment.

2. Description of the Related Art

Multi-monitor computer environments have become increasingly common for both home and professional use. For example, multiple screens can be placed close together so that it appears almost as if there is one large screen. Video games have been developed, for example, which can take advantage of this capability to provide a more realistic experience for the user. In this case, an application running on a computer uses one or more video cards to output different portions of an image to each screen, such as a left-hand portion and a right hand portion. Or, multiple screens may be used to display information from different applications. For example, a stockbroker may use one screen to run an application that displays stock data, and another screen to run an application that displays news updates. Or, an office worker may use one screen for a word processing program and another screen for an email program. The different applications may run on one or more computers. In another possible scenario, a split screen arrangement is used where a single screen is divided into two or more display regions, and information from one or more applications running on a computer is displayed in the different display regions. The above and other scenarios are common in a wide variety of applications, including computer aided design, medical diagnostic imaging, desktop publishing, word processing, video games, and the like. Moreover, with advances in flat panel technology and reduced prices and energy consumption, multi-monitor computing environments are expected to become increasingly common.

To interact with the information in a screen or other display region, the user must be informed of which screen is ready to receive commands from the user, and the location in the screen where the command will be carried out. This is typically achieved by displaying a cursor on the screen. As a familiar example, in a word processing program, the cursor may be a blinking icon, such as an underline, vertical line or block, that informs the user of the location where text will appear when the user types on a keyboard, or the location where the user can edit existing text, such as by cutting and pasting text. In a graphics program, the cursor may appear as a cross hairs, for instance, for identifying the location in an image where a command will be carried out, such as to change the color or other characteristics of the image. The user uses a cursor control device that can be a mouse or other pointing device, to move the cursor within a screen.

However, various difficulties arise in moving the cursor to a different screen or display region. In one possible approach, a keyboard command or on-screen icon can be selected by the user when the user wishes to move the cursor to another screen. Other approaches have been developed which interpret the movement of the cursor to the edge of one screen as a request to re-position the cursor on another screen. Such approaches are problematic since they can divert the user's attention from the current task, and require manual re-positioning of the cursor on the new screen. Moreover, a significant movement of the cursor control device is typically needed, which is inconvenient for all users, and problematic for users with limited physical dexterity. To reduce the required motion, the sensitivity of the cursor control device can be increased, thereby increasing the amount of on-screen movement relative to the amount of movement of the cursor control device. However, this makes fine control of the cursor control device more difficult.

### BRIEF SUMMARY OF THE INVENTION

To overcome these and other deficiencies in the prior art, the present invention provides a technique for allowing a user to quickly switch between screens in a multi-monitor environment using a cursor control device. In one possible approach, available programmable buttons on the cursor control device are programmed to achieve the desired functionality for switching between display regions on different screens, or within a screen.

In one aspect of the invention, a cursor control device includes at least one user-actuable component, and circuitry for detecting an actuation of the at least one user-actuable component and generating a corresponding signal for use by at least one computer in causing a cursor to switch from a first display region to a second display region.

In another aspect of the invention, at least one computer includes at least a first interface for receiving signals from a cursor control device, at least one processor for processing the received signals, and at least a second interface for sending signals to at least a first display region and a second display region, responsive to the at least one processor. The received signals include a first signal that is generated by the cursor control device upon actuation of at least one user-actuable component of the cursor control device. Furthermore, the at least one processor is responsive to the first signal for causing the at least a second interface to send signals to the at least a first display region and the second display region for causing the cursor to switch from the first display region to the second display region.

In another aspect of the invention, a method for programming a cursor control device includes receiving a user command, via an on-screen interface generated by at least one computer, that identifies a functionality to be programmed into the cursor control device. The functionality includes generating a signal for use by the at least one computer, when an actuation of at least one user-actuable component of the cursor control device is detected, to cause a cursor to switch from a first display region to a second display region. The method further includes sending signals from the at least one computer to the cursor control device, responsive to the receipt of the user command, for programming the functionality into the cursor control device.

Related program storage devices are also provided.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 illustrates a multi-monitor computing environment with a cursor control device configured for quick screen switching, according to the invention;

FIG. 2 illustrates a block diagram of components in the multi-monitor computing environment of FIG. 1, according to the invention;

FIG. 3 illustrates a cursor switching from a first display region of a first screen to a predetermined location in a second display region of a second screen;

FIG. 4 illustrates a cursor switching from a first display region of a first screen to a corresponding location in a second display region of a second screen;

FIG. 5 illustrates a cursor switching from a first display region of a screen to a corresponding location in a second display region of the screen; and

FIG. 6 illustrates a user interface for programming a cursor control device to configure it for quick screen switching, according to the invention.

### DETAILED DESCRIPTION OF THE INVENTION

The invention generally involves a method and system for providing instant switching between different display regions, where a display region refers to a screen or portion thereof.

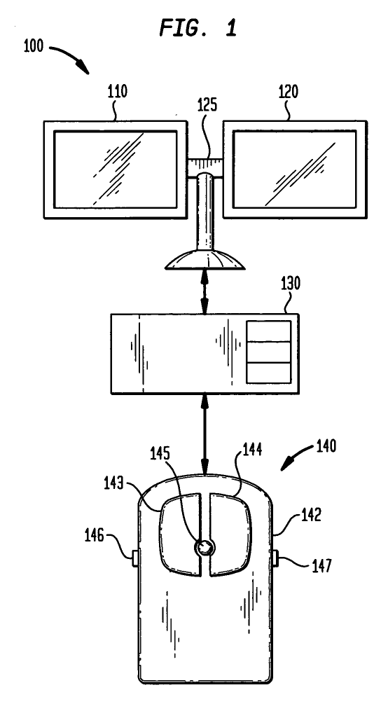

FIG. 1 illustrates a multi-monitor computing environment with a cursor control device configured for quick screen switching, according to the invention. The computing environment, shown generally at 100, includes two example monitors 110 and 120 connected by a bracket 125, a computer 130 and a cursor control device 140. While two monitors with respective screens are shown as an example, the invention is suitable for use with a single screen or any number of multiple screens. The cursor control device 140 can include a pointing device such as a mouse, for instance. Various types of mouses are available including those that are connected by a wire to the computer 130, e.g., using a PS/2 connector, and those that communicate via a wireless RF link with the computer 130. Moreover, movement of the mouse can be detected by a movement of a ball, when the mouse is moved across a pad, or by an optical system in a so-called optical mouse. Other cursor control devices include pen shaped devices, track balls, joysticks, glide pads, game pads, and devices that can be worn by a user such as for playing a video game.

The cursor control device 140 may include one or more user-actuable buttons or switches carried by a housing 142. For instance, switches 143 and 144 are used for left clicking and right clicking, respectively. A central button 145 or other device may be used for moving up or down incrementally by one line in a document, for instance. Switches 146 and 147, which are user-actuable components, and which may be side-mounted on the housing 142, for example, may be programmable buttons that can be programmed as discussed herein to provide quick screen switching. Recently, cursor control devices with a number of user-programmable buttons have become available. Conventionally, the user can program the buttons to perform functions such as entering a command within the context of an application. The present invention provides a new functionality for such programmable buttons. Although an example is provided in which the user can program the buttons using an on-screen user interface, it is also possible for the buttons to be programmed at the time of manufacture of the cursor control device. Or, the buttons can be programmed automatically by an application that is run on the computer 130, or in other ways.

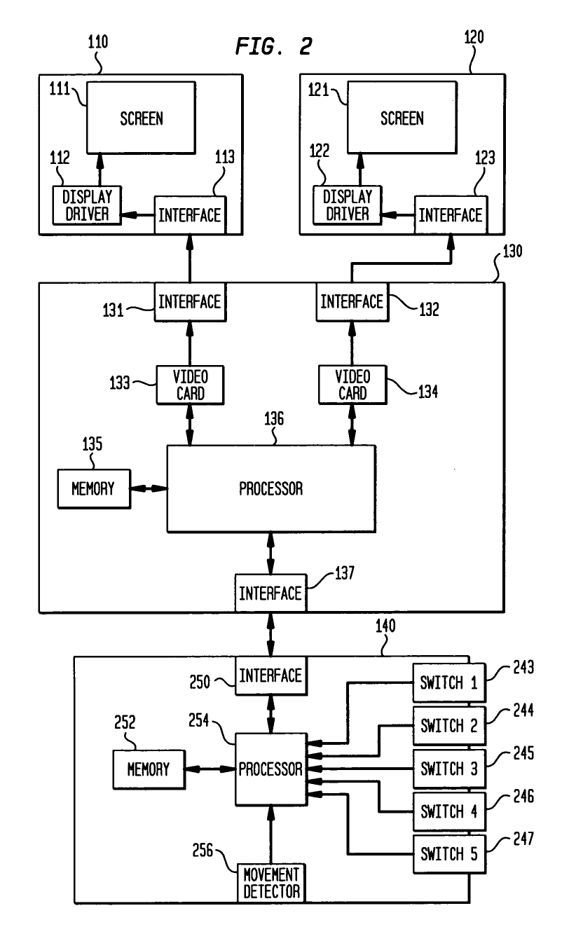

FIG. 2 illustrates a block diagram of components in the multi-monitor computing environment of FIG. 1, according to the invention. The monitor 110 includes a screen or display region 111 that is driven by a display driver 112 in response to signals received from the computer 130 via the monitor's interface 113. Similarly, the monitor 120 includes a screen or display region 121 that is driven by a display driver 122 in response to signals received from the computer 130 via the monitor's interface 123. In this example, one computer is used to drive both monitors 110 and 120.

However, it is also possible for multiple computers to drive multiple monitors. For example, multiple computers can be controlled by a single pointing device or keyboard in the manner disclosed in U.S. Pat. No. 6,069,615, entitled “Single Pointing Device/Keyboard For Multiple Computers”, issued May 30, 200 to D. W. Abraham et al., assigned to IBM Corp., and incorporated herein by reference. In the approach of D. W. Abraham et al., a single keyboard and mouse are connected to a fanout box, which in turn is connected to the keyboard and mouse ports of different computers, each having an associated monitor. A fanout switching unit detects movements of the mouse to determine when to switch the cursor to another computer's monitor. The present invention can be used to modify this approach by providing a cursor control device as described herein to replace the conventional mouse used by D. W. Abraham et al. to provide quick switching between the different monitors.

Returning to the example of FIG. 2, the computer 130 includes a processor 136 and memory 135. The memory 135 may be considered to be a program storage device that tangibly embodies instructions, such as software, firmware and/or micro code that are executed by at least one processor, such as the processor 136, to achieve the functionality described herein. The processor 136 may control one or more video cards. For example, a video card 133 may be controlled to send signals via an interface 131 to the monitor 110 to generate a display on the screen 111. Similarly, a video card 134 may be controlled to send signals via an interface 132 to the monitor 120 to generate a display on the screen 121. Thus, in this example approach, a separate video card and interface are used for each monitor. However, other approaches may be used as well. For example, a single video card may send a common signal to each monitor, where processing is performed at the monitors to display an appropriate portion of an image carried in the signal. In another approach, the video cards 133 and 134 send respective signals to one monitor via the corresponding interface, e.g., to monitor 110 via interface 131, e.g., for use in a split screen or inset sub-window display.

The computer 130 uses an interface 137 to communicate with the cursor control device 140 via a wired or wireless path. The cursor control device 140 similarly includes an interface 250 for communicating with the computer 130. A processor 254 detects when the various user-actuable switches of the curser control device 140, including example switches 243, 244, 245, 246 and 247, corresponding to switches 143, 144, 145, 146 and 147, respectively, in FIG. 1, for instance, are actuated. A memory 252 may be considered to be a program storage device that tangibly embodies instructions, such as software, firmware and/or micro code that are executed by at least one processor, such as the processor 254, to achieve the functionality described herein. The processor 254 may also receive signals from a movement detector 256, which detects when the cursor control device 140 is moved by the user. As mentioned, movement of the cursor control device 140 can be detected by a mechanical roller ball system, in which the device 140 is a mouse that is moved across a pad, or by an optical system, e.g., in an optical mouse, pen or other pointing device.

The movement detector 256 and processor 254 constitute circuitry for detecting user-initiated movement of the cursor control device and generating a corresponding signal for use by at least the computer 130 in controlling a position of a cursor in a first display region, such as the screen 111, according to the user-initiated movement. Furthermore, the switches 246 and 247 and processor 254 constitute circuitry for detecting an actuation of at least one user-actuable component, e.g., buttons 146 and 147, and generating a corresponding signal for use by at least the computer 130 in causing a cursor to switch from the first display region, e.g., the screen 111, to a second display region, e.g., the screen 121.

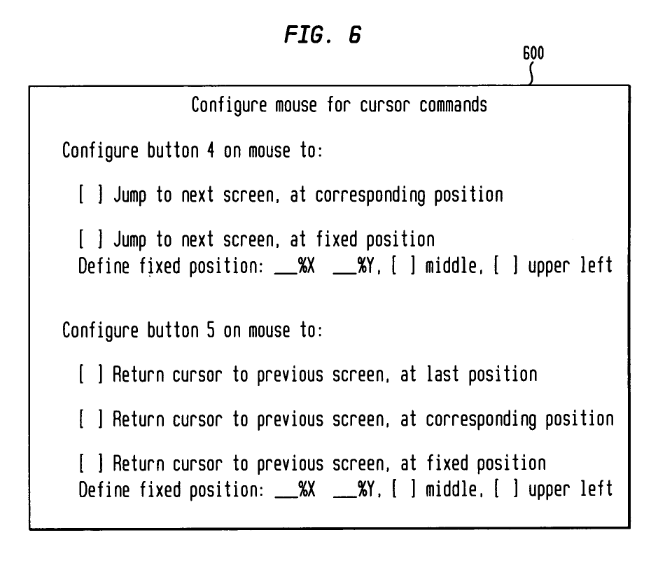

The computer 130 may include software, such as in the memory 135, which is used to generate an on-screen user interface, as discussed further below in connection with FIG. 6, to assist the user in programming the cursor control device. When the user enters commands via the interface, the computer 130 sends signals to the cursor control device 140 to program it accordingly. For example, the user may program the buttons 146 and 147 to cause the cursor to switch between display regions in a desired way, as discussed further below.

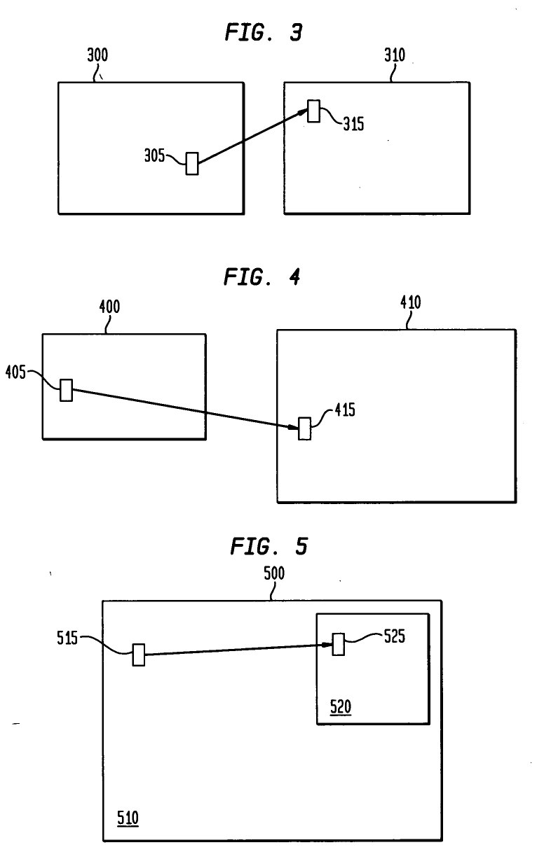

FIG. 3 illustrates a cursor 305 switching from a first display region 300 of a first screen to provide a cursor 315 at a predetermined location in a second display region 310 of a second screen. The cursor 305 may be switched when the user presses one of the buttons 146 and 147 on the cursor control device 140, for instance. The predetermined location in the second display region 310 in this case has been defined to be an upper left-hand portion of the second display region 315. However, any predetermined location including, e.g., the center of the second display region 310, can be used. The predetermined location in the second display region is independent of the cursor position in the first display region.

FIG. 4 illustrates a cursor 405 switching from a first display region 400 of a first screen to provide a cursor 415 at a corresponding location in a second display region 410 of a second screen. The cursor 405 may be switched when the user presses one of the buttons 146 and 147 on the cursor control device 140, for instance. The corresponding location in the second display region 410 in this case can be defined by the position of the cursor 405 in the first display region 400 when the buttons 146 and 147 are activated using appropriate coordinates. For example, the position of the cursor 405 in the first display region 400 can be defined using x,y coordinates, where x denotes the horizontal position and y denotes the vertical position. The position can be expressed in terms of an absolute distance, e.g., millimeters or inches, in terms of a number of pixels, or in terms of a proportionate position, e.g., in percentage, for example. For instance, the cursor 405 is at an x position that is 10% of the horizontal scale, and at a y position that is 50% of the vertical scale. The corresponding location of the cursor 415 in the second display region 410 is thus defined at the same relative position. The second display region 410 is shown as being about four times larger than the first display region 400 to illustrate that the concept can be used with different sized display regions.

FIG. 5 illustrates a cursor 515 switching from a first display region 510 of a screen to provide a cursor 525 at a corresponding location in a second display region 520 of the same screen. This is an example of multiple displays on one screen. The smaller display 520 may be considered to be an inset sub-window, for instance. The cursor 515 may be switched when the user presses one of the buttons 146 and 147 on the cursor control device 140, for instance. The corresponding location in the second display region 520 in this case is the upper left-hand portion of the second display region 520. Optionally, any predetermined location on the second display region 520 can be used.

Various other examples will be apparent. Moreover, multiple cursor movements can be achieved as well. For instance, a cursor may be switched back and forth between two display regions when the same button on the cursor control device 140 is pressed. Or, the cursor may be switched from a first display region to a second display region when a first button is pressed, and from the second display region to the first display region when a second button is pressed. When there are more than two display regions, the cursor may be cycled among the display regions, e.g., from left to right, or clockwise, e.g., from a first to a second to a third display region, upon successive presses of a first button. Optionally, successive presses of a second button cause the cursor to be cycled among the display regions in the opposite direction, e.g., from right to left, or counterclockwise. Furthermore, in any case, the user can define whether the cursor is to move to a previous location, a corresponding location, or a predetermined location.

FIG. 6 illustrates a user interface for programming a cursor control device to configure it for quick screen switching, according to the invention. Generally, there are various ways to program the computer 130 and cursor control device 140 to achieve the functionality described herein. In one approach, an implementation of the invention involves writing code that interfaces with the operating system of the computer 130. The code allows the user to select a mapping of the buttons on the cursor control device 140 to an operating system call that repositions the cursor on another display region in the same or a different screen. The mouse option panel of a windows based program may be used for this purpose.

Some cursor control devices, such as those available from Logitech (Fremont, Calif.), use their own configuration programs that provide more flexibility than the default windows mouse settings. In other operating systems, such as those of Linux or Apple Corp. (Mac OS X), the option to enable this feature could be provided in the operating system directly, in the shell program options panel, or in a configuration file, for instance. In any operating system, the cursor control device is interpreted by the desktop environment, which can interrupt input signals from the cursor control device.

The user interface 600 provides an example of the options that can be offered to the user. In the example shown, the user can configure button 4 on a mouse, e.g., button 146 on the cursor control device 140 of FIG. 1, to cause the cursor to jump to the next screen, at a corresponding position, or jump to the next screen at a fixed position. In the latter case, the user can define the fixed position, such as by percentages in the x and y directions, or in the middle or upper left of the next screen. The user can similarly configure button 5 on the mouse, e.g., button 147 on the cursor control device of FIG. 1, to cause the cursor to return to the previous screen, at its last position, at a corresponding position as in the current screen, or at a fixed location. In the latter case, again, the user can define the fixed position.

Once the user enters the desired configuration, the computer 130 sends signals to the cursor control device 140 to configure the device accordingly. In particular, the cursor control device 140 stores the information sent by the computer 130 and reacts to button presses in a manner that is dictated by the information, e.g., by generating a signal for use by the computer in switching the cursor among display regions as desired by the user. Note that the cursor control device 140 can be programmed with default settings either automatically by the computer or at the time of manufacture, in which case the user interface 600 is not required, or the user interface 600 may be used optionally to change the default settings. Moreover, it will be appreciated that the user interface 600 is an example only as various other interfaces may be used.

Generally, a method for programming a cursor control device can include receiving a user command, via an on-screen interface such as the interface 600 generated by at least one computer, that identifies a functionality to be programmed into the cursor control device. The functionality involves generating a signal for use by the at least one computer, when an actuation of at least one user-actuable component, e.g., buttons 146 or 147, of the cursor control device is detected, to cause a cursor to switch from a first display region to a second display region. The method further includes sending signals, e.g., commands, from the at least one computer to the cursor control device, responsive to the receipt of the user command, for programming the functionality into the cursor control device.

A method for deploying computing infrastructure may similarly be provided. Such a method includes integrating computer-readable code into at least one computer, where the code in combination with the at least one computer is capable of performing a method for programming a cursor control device as indicated herein. The code may be provided by a portable storage medium such as a CD-ROM, or downloaded from a web site and stored on a hard drive of the computer 130, for instance

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

What is claimed is:

1. A cursor control device, comprising:
at least one user-actuable component; and
circuitry for detecting an actuation of the at least one user-actuable component and generating a corresponding signal for use by at least one computer in causing a cursor to switch from a first display region to a second display region.

2. The cursor control device of claim 1, wherein:
the first display region comprise a first screen; and
the second display region comprises a second screen.

3. The cursor control device of claim 1, wherein:
the first display region comprise a first portion of a screen; and
the second display region comprises a second portion of the screen.

4. The cursor control device of claim 1, wherein:
the at least one computer includes first and second computers;
the first display region is associated with the first computer; and
the second display region is associated with the second computer.

5. The cursor control device of claim 1, wherein:
the at least one user-actuable component comprises a button.

6. The cursor control device of claim 1, further comprising:
circuitry for detecting a further actuation of the at least one user-actuable component and generating a corresponding signal for use by the at least one computer in causing the cursor to switch from the second display region to the first display region.

7. The cursor control device of claim 1, further comprising:
circuitry for detecting a further actuation of the at least one user-actuable component and generating a corresponding signal for use by the at least one computer in causing the cursor to switch from the second display region to a third display region.

8. The cursor control device of claim 1, wherein:
the at least one user-actuable component comprises at least first and second user-actuable components;
an actuation of the first user-actuable component is detected for generating the signal for use by the at least one computer in causing the cursor to switch from the first display region to the second display region; and
an actuation of the second user-actuable component is detected for generating a corresponding signal for use by the at least one computer in causing the cursor to switch from the second display region to the first display region.

9. The cursor control device of claim 1, wherein:
the signal for use by the at least one computer causes the cursor to switch to a position on the second display region that corresponds to a position of the cursor on the first display region.

10. The cursor control device of claim 1, wherein:
the signal for use by the at least one computer causes the cursor to switch to a predetermined position on the second display region that is independent of a position of the cursor on the first display region.

11. The cursor control device of claim 1, further comprising:
an interface for receiving commands from the at least one computer;
wherein the circuitry for detecting the actuation of the at least one user-actuable component is programmed by the at least one computer, via the commands received by the interface, to generate the corresponding signal for use in causing the cursor to switch from the first display region to the second display region.

12. The cursor control device of claim 1, further comprising:
circuitry for detecting user-initiated movement of the cursor control device and generating a corresponding signal for use by at least one computer in controlling a position of the cursor on the first display region according to the user-initiated movement.

13. The cursor control device of claim 1, further comprising:
a housing;
wherein the at least one user-actuable component is carried by the housing; and
the circuitry is provided within the housing.

14. At least one computer, comprising:
at least a first interface for receiving signals from a cursor control device;
at least one processor for processing the received signals; and
at least a second interface for sending signals to at least a first display region and a second display region, responsive to the at least one processor; wherein:
the received signals include a first signal that is generated by the cursor control device upon actuation of at least one user-actuable component of the cursor control device; and
the at least one processor is responsive to the first signal for causing the at least a second interface to send signals to the at least a first display region and the second display region for causing the cursor to switch from the first display region to the second display region.

15. The at least one computer of claim 14, wherein:
the first display region comprise a first screen; and
the second display region comprises a second screen.

16. The at least one computer of claim 14, wherein:
the first display region comprise a first portion of a screen; and
the second display region comprises a second portion of the screen.

17. The at least one computer of claim 14, wherein:
the at least one computer includes first and second computers;
the first display region is associated with the first computer; and
the second display region is associated with the second computer.

18. The at least one computer of claim 14, wherein:
the received signals include a second signal that is generated by the cursor control device upon a further actuation of the at least one user-actuable component; and
the at least one processor is responsive to the second signal for causing the at least a second interface to send signals to the at least a first display region and the second display region for causing the cursor to switch from the second display region to the first display region.

19. The at least one computer of claim 14, wherein:
the received signals include a second signal that is generated by the cursor control device upon a further actuation of the at least one user-actuable component; and
the at least one processor is responsive to the second signal for causing the at least a second interface to send signals to the second display region and a third display region for causing the cursor to switch from the second display region to the third display region.

20. The at least one computer of claim 14, wherein:
the at least one processor is responsive to the first signal for causing the at least a second interface to send signals to the at least a first display region and the second display region for causing the cursor to switch to a position on the second display region that corresponds to a position of the cursor on the first display region.

21. The at least one computer of claim 14, wherein:
the at least one processor is responsive to the first signal for causing the at least a second interface to send signals to the at least a first display region and the second display region for causing the cursor to switch to a predetermined position on the second display region that is independent of a position of the cursor on the first display region.

22. The at least one computer of claim 14, wherein:
the received signals include a second signal that is generated by the cursor control device in correspondence with a detected user-initiated movement of the cursor control device; and
the at least one processor is responsive to the second signal for causing the at least a second interface to send signals to the at least a first display region for controlling a position of the cursor on the first display region according to the user-initiated movement.

23. A method for deploying computing infrastructure, comprising integrating computer-readable code into at least one computer, where the code in combination with the at least one computer is capable of performing a method for programming a cursor control device, the method comprising:
receiving a user command, via an on-screen interface, that identifies a functionality to be programmed into the cursor control device;
wherein the functionality comprises generating a signal for use by the at least one computer, when an actuation of at least one user-actuable component of the cursor control device is detected, to cause a cursor to switch from a first display region to a second display region; and
sending signals from the at least one computer to the cursor control device, responsive to the receipt of the user command, for programming the functionality into the cursor control device.

24. A method for programming a cursor control device, the method comprising:
receiving a user command, via an on-screen interface generated by at least one computer, that identifies a functionality to be programmed into the cursor control device;
wherein the functionality comprises generating a signal for use by the at least one computer, when an actuation of at least one user-actuable component of the cursor control device is detected, to cause a cursor to switch from a first display region to a second display region; and
sending signals from the at least one computer to the cursor control device, responsive to the receipt of the user command, for programming the functionality into the cursor control device.

25. At least one program storage device in at least one computer, wherein the at least one program storage device tangibly embodies a program of instructions executable by at least one processor in the at least one computer to perform a method for programming a cursor control device, the method comprising:
receiving a user command, via an on-screen interface generated by at least one computer, that identifies a functionality to be programmed into the cursor control device;
wherein the functionality comprises generating a signal for use by the at least one computer, when an actuation of at least one user-actuable component of the cursor control device is detected, to cause a cursor to switch from a first display region to a second display region; and
sending signals from the at least one computer to the cursor control device, responsive to the receipt of the user command, for programming the functionality into the cursor control device.

26. At least one program storage device in at least one computer, wherein the at least one program storage device tangibly embodies a program of instructions executable by at least one processor in the at least one computer to perform a method for controlling at least a first display region and a second display region, the method comprising:
receiving a first signal from a cursor control device that is generated by the cursor control device upon actuation of at least one user-actuable component of the cursor control device;
processing the first signal; and
sending signals to the at least a first display region and the second display region, responsive to the processing, for causing the cursor to switch from the first display region to the second display region.

27. The at least one program storage device of claim 26, further comprising:
receiving a second signal from the cursor control device that is generated by the cursor control device in correspondence with a detected user-initiated movement of the cursor control device; and
the processing is responsive to the second signal for sending signals to the first display region for controlling a position of the cursor on the first display region according to the user-initiated movement.

28. At least one program storage device in cursor control device, wherein the at least one program storage device tangibly embodies a program of instructions executable by at least one processor in the cursor control device to perform a method for sending signals to at least one computer, the method comprising:
detecting user-initiated movement of the cursor control device and generating a corresponding signal for use by at least one computer in controlling a position of a cursor in a first display region according to the user-initiated movement;
detecting an actuation of at least one user-actuable component of the cursor control device and generating a corresponding signal for use by the at least one computer in causing the cursor to switch from the first display region to a second display region.

29. The at least one program storage device of claim 28, wherein:
the first display region comprise a first screen; and
the second display region comprises a second screen.

30. The at least one program storage device of claim 28, wherein:
the first display region comprise a first portion of a screen; and
the second display region comprises a second portion of the screen.
